(19) United States
(12) Patent Application Publication
(10) Pub. No.: US 2017/0214956 A1
(43) Pub. Date: Jul. 27, 2017

(54) VIDEO TRANSMISSION DEVICE, TERMINAL, VIDEO TRANSMISSION SYSTEM, CONTROL METHOD, PROGRAM, AND INFORMATION STORAGE MEDIUM

(71) Applicant: Sony Interactive Entertainment Inc., Tokyo (JP)

(72) Inventors: Masahiro Fujihara, Tokyo (JP); Akira Miyashita, Tokyo (JP)

(73) Assignee: Sony Interactive Entertainment Inc., Tokyo (JP)

(21) Appl. No.: 15/328,950

(22) PCT Filed: Aug. 27, 2015
(86) PCT No.: PCT/JP2015/074185

§ 371 Date: Jan. 25, 2017

(30) Foreign Application Priority Data
Sep. 11, 2014 (JP) 2014-185258

(51) Int. Cl. H04N 21/2743; H04N 21/2187; H04N 21/4788

(52) U.S. Cl. CPC H04N 21/2743; H04N 21/4788; H04N 21/2187

(57) ABSTRACT

Provided are a video transmission device, a terminal, a video transmission system, a control method, a program, and an information storage medium that contribute to reduced time and effort for a user during communication of information on a video managed by a video delivery system that delivers the video using a terminal different from the video transmission device that sends the video to be delivered by live streaming. A video transmission section sends, to a video delivery system that delivers videos by live streaming, a video to be delivered by the video delivery system. A video-related information communication control section controls an information terminal associated with a gaming device such that information on the video managed by the video delivery system can be communicated with the video delivery system.

### TECHNICAL FIELD

The present invention relates to a video transmission device, a terminal, a video transmission system, a control method, a program, and an information storage medium.

### BACKGROUND ART

Recent years have seen the ease with which videos representing game playing details, videos shot with cameras, and other videos are delivered by live streaming using video delivery systems run by video delivery operators. For example, among gaming devices is one that if a predetermined operation is performed during play of a game executed on the gaming device, a video representing the game playing details is sent from the gaming device to a video delivery system. Then, the video sent to the video delivery system in that manner is delivered by live streaming.

Among such live streaming deliveries are those that allow users, video viewers and deliverers, to post their comments about a video during delivery of the video. The users can view, via a screen, information managed by the video delivery system such as comments posted in this manner.

### SUMMARY

### Technical Problem

If comments and other information on a video delivered by live streaming are shown on a single screen together with the video, the video is shown at a smaller size than when the video is shown over the entire screen. Therefore, it is common that while a video to be delivered by live streaming is shown over the entire screen, comments and other information on the video are shown on a different screen via a terminal such as smartphone or tablet. In such a manner, for example, if a video representing game playing details is delivered by live streaming, the video is shown over the entire screen, allowing the user to play a game readily.

In the above case, however, it is necessary to establish not only a communication between a video delivery system and a video transmission device that sends videos to the video delivery system such as gaming device but also another communication between the video delivery system and a terminal that shows comments. As a result, a user may handle tasks such as logging into the video delivery system and searching for the channel that delivers the above video by manipulating the terminal, thus requiring much time and effort.

The present invention has been devised in light of the above problem, and it is an object of the present invention to provide a video transmission device, a terminal, a video transmission system, a video transmission method, a communication method, a program, and an information storage medium that contribute to reduced time and effort for a user during communication of information on a video managed by a video delivery system that delivers the video using a terminal different from the video transmission device that transmits the video to be delivered by live streaming.

### Solution to Problem

In order to solve the above problem, a video transmission device according to the present invention includes a video transmission section adapted to send, to a video delivery system operable to deliver videos by live streaming, a video to be delivered by the video delivery system; and a communication control section adapted to control a terminal associated with the video transmission device such that information on the video managed by the video delivery system can be communicated with the video delivery system.

Further, a terminal according to the present invention includes a communication section adapted to communicate, with a video delivery system that delivers videos by live streaming and is the destination of the video sent from a video transmission device, information on the video managed by the video delivery system, the video transmission device sending the video to be delivered by the video delivery system and being associated with the terminal, wherein the communication section is controlled such that information on the video managed by the video delivery system, the destination of the video sent from the video transmission device, can be communicated with the video delivery system.

Still further, a video transmission system according to the present invention includes a video transmission device; and a terminal, wherein the video transmission device includes a video transmission section adapted to send, to a video delivery system that delivers videos by live streaming, a video to be delivered by the video delivery system, and a communication control section adapted to control the terminal associated with the video transmission device such that information on the video managed by the video delivery system can be communicated with the video delivery system, the terminal includes a communication section adapted to communicate, with the video delivery system, the destination of the video sent from the video transmission device, information on the video managed by the video delivery system, and the communication section is controlled such that the information on the video managed by the video delivery system, the destination of the video sent from the video transmission device, can be communicated with the video delivery system.

Still further, a control method according to the present invention includes a step of sending, by a video transmission device, a video to be delivered by a video delivery system that delivers videos by live streaming to the video delivery system; and a step of controlling a terminal associated with the video transmission device such that information on the video managed by the video delivery system can be communicated with the video delivery system.

Still further, another control method according to the present invention includes a step of communicating, by a terminal associated with a video transmission device sending a video to be delivered by a video delivery system that is the destination of the video sent from the video transmission device by live streaming to the video delivery system, information on the video managed by the video delivery system with the video delivery system; and a step of performing control such that information on the video managed by the video delivery system, the destination of the video sent from the video transmission device, can be communicated between the video delivery system and the terminal.

Still further, a program according to the present invention causes a computer to perform a procedure of sending, to a video delivery system that delivers videos by live streaming, a video to be delivered by the video delivery system; and a procedure of controlling a terminal associated with the computer such that information on the video managed by the video delivery system can be communicated with the video delivery system.

Still further, an information storage medium according to the present invention is a computer-readable information storage medium that stores a program. The program causes a computer to perform a procedure of sending, to a video delivery system that delivers videos by live streaming, a video to be delivered by the video delivery system; and a procedure of controlling a terminal associated with the computer such that information on the video managed by the video delivery system can be communicated with the video delivery system.

Still further, another program according to the present invention causes a computer to perform a procedure of communicating, with a video delivery system that delivers videos by live streaming and is the destination of a video sent from a video transmission device, information on the video managed by the video delivery system, the video transmission device sending the video to be delivered by the video delivery system and being associated with the computer, wherein the computer is controlled such that information on the video managed by the video delivery system, the destination of the video sent from the video transmission device, can be communicated with the video delivery system.

Still further, another information storage medium according to the present invention is a computer-readable information storage medium that stores a program. The program causes a computer to perform a procedure of communicating, with a video delivery system that delivers videos by live streaming and is the destination of a video sent from a video transmission device, information on the video managed by the video delivery system, the video transmission device sending the video to be delivered by the video delivery system and being associated with the computer, wherein the computer is controlled such that information on the video managed by the video delivery system, the destination of the video sent from the video transmission device, can be communicated with the video delivery system.

In one mode of the present invention, the information on the video is comments posted by users viewing the video delivered by the video delivery system by live streaming.

In the present mode, the communication control section may perform control such that the terminal can post comments through a communication session established between the terminal and the video delivery system. The communication session is used by the video transmission section to send the video.

Further, in the mode of the present invention, the communication control section relays communication of information on the video managed by the video delivery system between the video delivery system, the destination of the video sent from the video transmission section, and the terminal. The video transmission section sends the video by a communication scheme that is in keeping with the video delivery system, the destination of the video. The video transmission section communicates, with the terminal, the information on the video managed by the video delivery system, the destination of the video, by a common communication scheme that is independent of the video delivery system, the destination of the video sent from the video transmission section.

Still further, in the mode of the present invention, the terminal can be used by the video delivery system independently of the video transmission device.

### [BRIEF DESCRIPTION OF DRAWINGS]

FIG. 1 is a diagram illustrating an example of an overall configuration of a computer network according to an embodiment of the present invention.

FIG. 2 is a diagram schematically illustrating an example of a relationship among video delivery systems, a gaming device, and an information terminal.

FIG. 3 is a diagram illustrating an example of a viewing screen.

FIG. 4 is a diagram illustrating an example of a playing screen.

FIG. 5 is a diagram illustrating an example of an auxiliary screen.

FIG. 6 is a functional block diagram illustrating examples of functions implemented in a video transmission system according to the embodiment of the present invention.

FIG. 7 is a diagram illustrating an example of contact management data.

FIG. 8 is a flowchart illustrating an example of a processing flow performed by the video transmission system according to the present embodiment.

FIG. 9 is a diagram illustrating an example of a code entry screen.

FIG. 10 is a flowchart illustrating an example of a processing flow performed by the video transmission system according to the present embodiment.

FIG. 11 is a diagram illustrating an example of a connection confirmation screen.

FIG. 12 is a diagram illustrating an example of a second screen.

FIG. 13 is a flowchart illustrating an example of a processing flow performed by the video transmission system according to the present embodiment.

FIG. 14 is a diagram illustrating another example of a playing screen.

FIG. 15 is a diagram illustrating another example of an auxiliary screen.

### DESCRIPTION OF EMBODIMENT

A detailed description will be given below of an embodiment of the present invention with reference to the accompanying drawings.

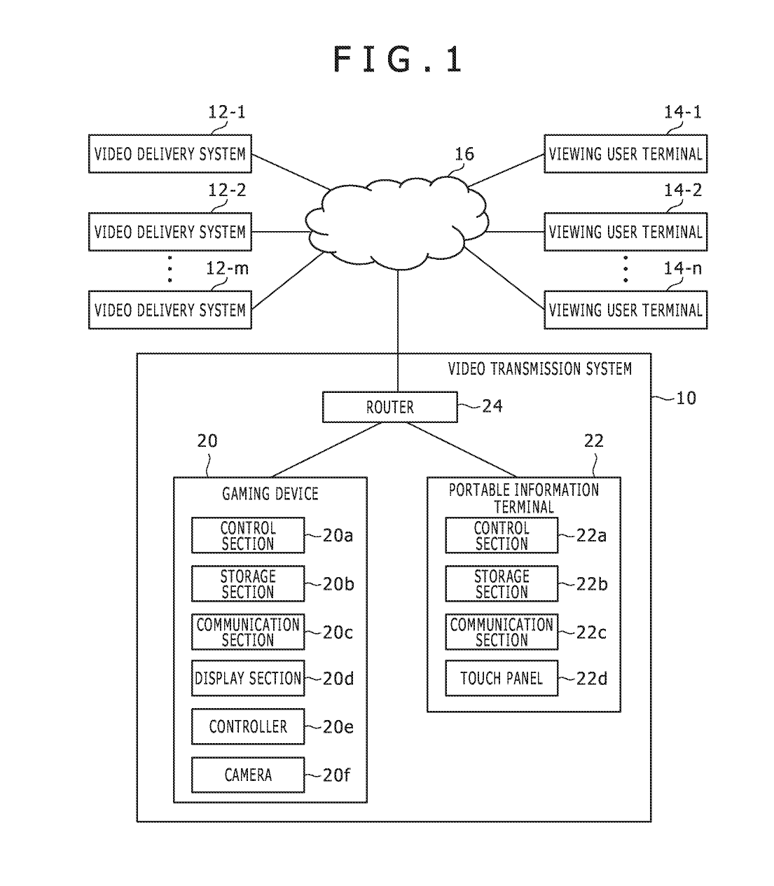

FIG. 1 is a diagram illustrating an example of an overall configuration of a computer network according to an embodiment of the present invention. As illustrated in FIG. 1, a video transmission system 10, a plurality of video delivery systems 12 (12-1 to 12-m), and a plurality of viewing user terminals 14 (14-1 to 14-n), each of which includes a computer as a main component, are connected to a computer network 16 such as the Internet. Then, the video transmission system 10, the video delivery systems 12, and the viewing user terminals 14 can communicate with each other.

The video delivery systems 12 according to the present embodiment are computers such as servers that provide video delivery services such as video live streaming service.

The video transmission system 10 according to the present embodiment is an information processing system used by a user who delivers a video to be delivered by the video delivery system 12 by live streaming. A user using the video transmission system 10 will be hereinafter referred to as a delivering user.

In the present embodiment, the video transmission system 10 includes a gaming device 20, an information terminal 22, and a router 24.

The gaming device 20 is a computer such as game console that serves as a video transmission device in the present embodiment. It should be noted that the gaming device 20 may be a portable gaming device. Alternatively, a computer such as personal computer, smartphone, or tablet terminal rather than the gaming device 20 may serve as a video transmission device. The gaming device 20 according to the present embodiment includes, for example, a control section 20a, a storage section 20b, a communication section 20c, a display section 20d, a controller 20e, and a camera 20f. The control section 20a is a program-controlled device such as CPU (Central Processing Unit), performing various information processing tasks in accordance with a program stored in the storage section 20b. The storage section 20b is, for example, a storage element such as ROM (Read Only Memory) and RAM (Random Access Memory) or a hard disk drive. The communication section 20c is, for example, a communication interface used to exchange data with computers such as the video delivery systems 12 via the computer network 16. The gaming device 20 sends and receives information to and from computers such as the video delivery systems 12 via the communication section 20c. The display section 20d is, for example, a liquid crystal display that shows a screen or the like generated by the control section 20a. The controller 20e is, for example, an operating member used to make an operation input to the control section 20a. The camera 20f is, for example, a digital camera that outputs a captured image of a subject to the control section 20a.

The information terminal 22 is a portable computer such as smartphone and tablet terminal in the present embodiment. It should be noted that the information terminal 22 may be a stationary computer. The information terminal 22 according to the present embodiment includes, for example, a control section 22a, a storage section 22b, a communication section 22c, and a touch panel 22d. The control section 22a is a program-controlled device such as CPU, performing various information processing tasks in accordance with a program stored in the storage section 22b. The storage section 22b is, for example, a storage element such as ROM and RAM or a hard disk drive. The communication section 22cis, for example, a communication interface used to exchange data with computers such as the video delivery systems 12 via the computer network 16. The information terminal 22 sends and receives information to and from computers such as the video delivery systems 12 via the communication section 22c. The touch panel 22d is, for example, a combination of a touch sensor and a display such as liquid crystal display in one piece. The touch panel 22d shows a screen or the like generated by the control section 22a. Further, a delivering user can make an operation input to the control section 22a by performing various operations such as tapping on the touch panel 22d.

The gaming device 20 and the information terminal 22 are connected, in a wired or wireless manner, to the router 24 that is connected to the computer network 16. Then, the gaming device 20 and the information terminal 22 communicate, via the router 24, with the video delivery systems 12 and the viewing user terminals 14 that are connected to the computer network 16.

The viewing user terminals 14 according to the present embodiment are, for example, computers such as personal computers, game consoles, portable gaming devices, and information terminals used by users viewing videos that are delivered by delivering users by live streaming. A user viewing videos delivered by delivering users by live streaming will be hereinafter referred to as a viewing user.

Account information such as user IDs (Identifications) and passwords is stored in the video delivery systems 12 according to the present embodiment. The account information is used to manage users using video delivery services provided by the video delivery systems 12. In the present embodiment, account information such as the above delivering users and viewing users is stored in the video delivery systems 12.

In the present embodiment, various services provided by the video delivery system 12 become available for a delivering user when the delivering user accesses the video delivery system 12 from the gaming device 20, enters his or her account information, and logs into the video delivery system 12. Here, specifically, a service for delivering, to viewing users, videos sent to the video delivery system 12 by live streaming, for example, becomes available for the delivering user.

On the other hand, various services provided by the video delivery system 12 become available for a viewing user when the viewing user accesses the video delivery system 12 from the viewing user terminal 14, enters his or her account information, and logs into the video delivery system 12. Here, specifically, viewing of videos delivered from the video delivery system 12 and provided by delivering users, for example, becomes available for the viewing user.

It should be noted that some of the services provided by the video delivery system 12 may be available even for those users whose account information is not registered in the video delivery system 12.

It should be noted that the plurality of video delivery systems 12 are independent of each other and each thereof is managed by a different delivery operator in the present embodiment. Therefore, account information of a user using the plurality of video delivery systems 12 registered in each of the video delivery systems 12 may be different.

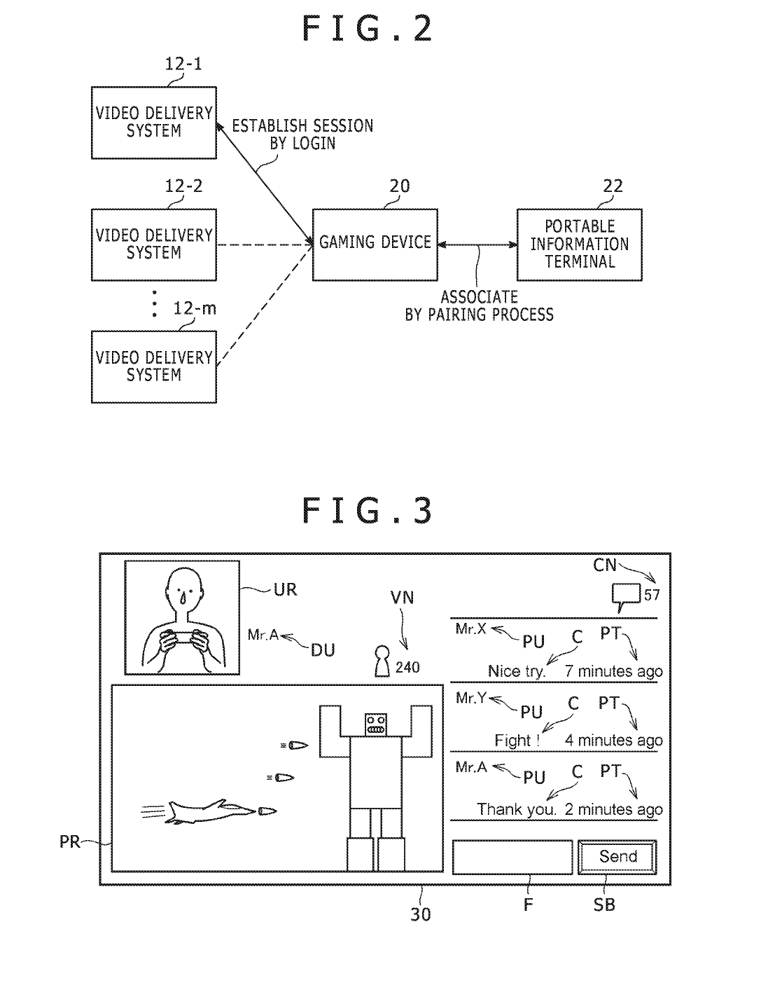

A description will be given here of an example of delivery of videos by live streaming performed in the present embodiment. FIG. 2 is a diagram schematically illustrating an example of a relationship between the video delivery systems 12, the gaming device 20, and the information terminal 22 in live streaming delivery. In the present embodiment, a game program is installed in the gaming device 20. Then, in the present embodiment, the gaming device 20 and the information terminal 22 are associated with each other by a pairing process which will be described later. We assume here that a delivering user performs an operation to specify which video delivery system 12 to use for live streaming delivery before or while playing the game. We assume here, for example, that the delivering user performs an operation to specify a first video delivery system 12-1. Then, in the present embodiment, the gaming device 20 sends the delivering user's account information in the first video delivery system 12-1 stored in the storage section 20b to the first video delivery system 12-1, thus logging into the first video delivery system 12-1. As a result, a communication session is established between the gaming device 20 and the first video delivery system 12-1, thus allowing the gaming device 20 to use the first video delivery system 12-1. Then, in the present embodiment, the delivery of a playing video representing playing details of the game being played to a viewing user begins using the specified first video delivery system 12-1.

FIG. 3 is a diagram illustrating an example of a viewing screen 30 appearing on the display of the viewing user terminal 14. The viewing screen 30 contains a playing video display area PR in which a playing video representing game playing details of a delivering user appears. Frame images which make up the playing video and are generated by the gaming device 20 are shown one after another in the playing video display area PR. Further, the viewing screen 30 contains a delivering user video display area UR in which a delivering user video, a video showing the delivering user playing the game, appears. Frame images making up the delivering user video are shown one after another in the delivering user video display area UR.

Further, the viewing screen 30 also contains comments C. In the present embodiment, delivering and viewing users can post the comments C on a playing video during delivery of the playing video by live streaming. Then, of the comments C posted, a given number of the comments C that were posted most recently are contained in the viewing screen 30. Still further, the viewing screen 30 contains poster's name information PU and posting timing information PT in such a manner as to be associated with the comment C. The poster's name information PU represents the poster's name of the comment C. The posting timing information PT represents when the comment C was posted. The posting timing information PT according to the present embodiment represents how long ago from now the comment C was posted.

In addition, the viewing screen 30 also contains delivering user name information DU, viewing user count information VN, and comment count information CN. The delivering user name information DU represents the delivering user's name. The viewing user count information VN represents the number of users viewing the playing video. The comment count information CN represents the number of comments C posted during delivery of the playing video. Further, the viewing screen 30 contains a form F and a send button SB. The form F is provided for a viewing user to enter the comment C to be posted. The send button SB is provided to post the comment C entered in the form F.

In the present embodiment, information on the playing video delivered by the first video delivery system 12-1 is managed by the first video delivery system 12-1. Among examples of such information are the above comments C, poster's name information PU, posting timing information PT, delivering user name information DU, viewing user count information VN, and comment count information CN. Further, an example of such information is elapsed time from the beginning of delivery of playing video. Information on a video managed by the video delivery system 12 that delivers the video by live streaming as described above will be hereinafter referred to as video-related information.

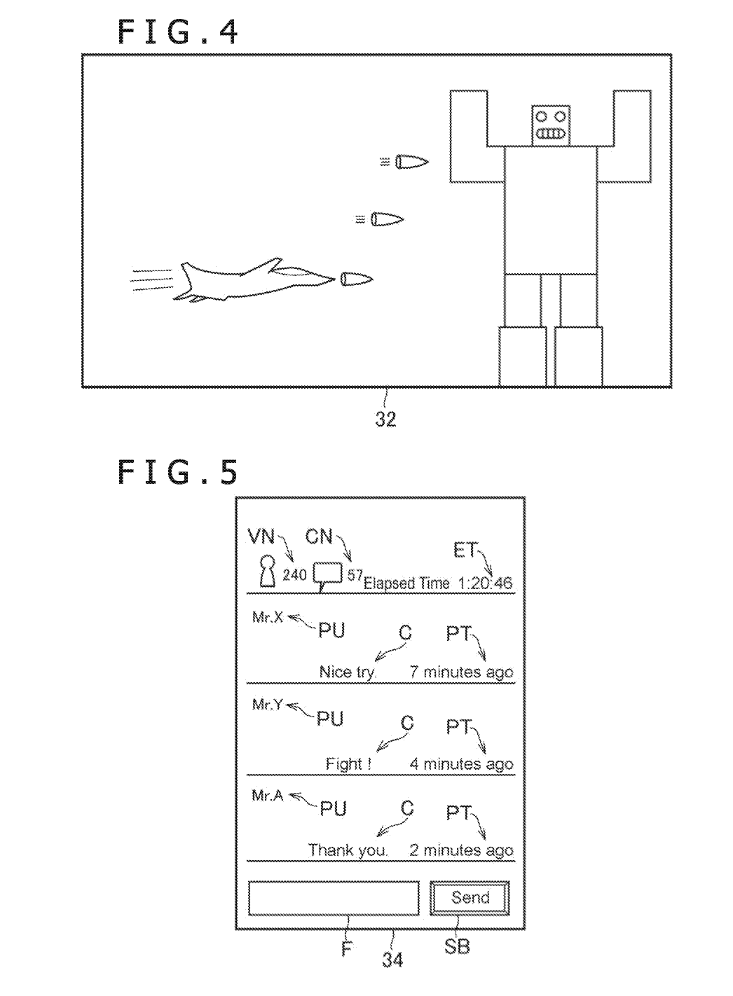

FIG. 4 is a diagram illustrating an example of a playing screen 32 that appears on the display section 20d of the gaming device 20 during delivery of a playing video. The playing screen 32 shows, one after another, frame images which make up the playing video and are generated by the gaming device 20. In the present embodiment, a playing video appears over the entire display section 20d of the gaming device 20 as illustrated in FIG. 4.

FIG. 5 is a diagram illustrating an example of an auxiliary screen 34 that appears on the touch panel 22d of the information terminal 22 during delivery of a playing video. In the present embodiment, video-related information appears on the touch panel 22d of the information terminal 22, and not on the gaming device 20d of the delivering user as illustrated in FIG. 5. The auxiliary screen 34 illustrated in FIG. 5 contains a given number of the most recent comments C posted in such a manner as to be associated with the poster's name information PU and the posting timing information PT. Further, the auxiliary screen 34 also contains the viewing user count information VN and the comment count information CN. Still further, the auxiliary screen 34 also contains elapsed time information ET representing the time elapsed from the beginning of the game play. Yet further, the auxiliary screen 34 contains the form F and the send button SB, allowing the delivering user to post the comment C on the playing video using the information terminal 22. Thus, the comment C to be posted is done so via a communication session established between the gaming device 20 and the first video delivery system 12-1. Thus, the information terminal 22 according to the present embodiment can communicate information with the video delivery systems 12 via communication sessions established between the gaming device 20 and the video delivery systems 12.

In the present embodiment, video-related information appears on the auxiliary screen 34 as described above even if the information terminal 22 has not established a communication with the first video delivery system 12-1, for example, by logging into the first video delivery system 12-1. Further, the information terminal 22 can send the comment C to the first video delivery system 12-1 even without establishing a communication with the first video delivery system 12-1. Thus, the present embodiment contributes to reduced time and effort for delivering users when video-related information is communicated with the information terminal 22, a terminal separate from the gaming device 20.

Further, in the present embodiment, the auxiliary screen 34, which is in keeping with the video delivery system 12 delivering playing videos by live streaming, appears on the touch panel 22d of the information terminal 22. That is, the auxiliary screen 34 illustrated in FIG. 5 is in keeping with the first video delivery system 12-1. We assume here, for example, that the gaming device 20 logs into a second video delivery system 12-2 and that the second video delivery system 12-2 delivers a playing video. In this case, the auxiliary screen 34 that is in keeping with the second video delivery system 12-2 appears on the touch panel 22d of the information terminal 22. Further, information on the playing video managed by the second video delivery system 12-2 appears on the auxiliary screen 34. Further, in this case, the comment C entered into the information terminal 22 is posted via a communication session established between the second video delivery system 12-2 and the gaming device 20. Similarly in this case, there is no need for the information terminal 22 to establish a communication with the second video delivery system 12-2, for example, by logging into the second video delivery system 12-2. Therefore, the present embodiment allows for the information terminal 22 to communicate information with the video delivery system 12 engaged in communication with the gaming device 20 without establishing a communication with the video delivery system 12, for example, by login operation.

It should be noted that the information terminal 22 according to the present embodiment may be a terminal that in itself can be used by the video delivery system 12 independently of the gaming device 20. More specifically, various services provided by the video delivery system 12 may become available if the information terminal 22 according to the present embodiment logs into the video delivery system 12. On the other hand, the information terminal 22 according to the present embodiment may be a terminal that in itself cannot be used by the video delivery system 12.

A description will be given below of functions implemented in the video transmission system 10 according to the present embodiment and processes performed by the video transmission system 10.

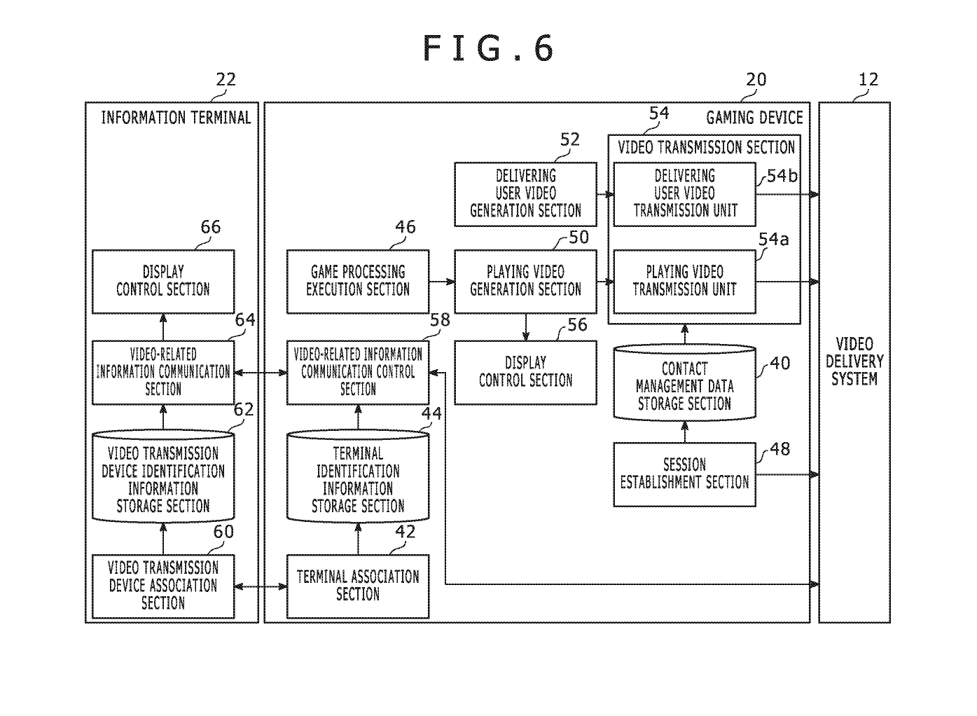

FIG. 6 is a functional block diagram illustrating examples of functions implemented in the video transmission system 10 according to the present embodiment. It should be noted that not all the functions illustrated in FIG. 6 need to be implemented in the video transmission system 10 according to the present embodiment and that functions other than those illustrated in FIG. 6 may be implemented.

As illustrated in FIG. 6, the gaming device 20 according to the present embodiment functionally includes, for example, a contact management data storage section 40, a terminal association section 42, a terminal identification information storage section 44, a game processing execution section 46, a session establishment section 48, a playing video generation section 50, a delivering user video generation section 52, a video transmission section 54, a display control section 56, and a video-related information communication control section 58. On the other hand, the video transmission section 54 includes a playing video transmission unit 54a and a delivering user video transmission unit 54b. The contact management data storage section 40 and the terminal identification information storage section 44 are primarily implemented as the storage section 20b. The terminal association section 42 is primarily implemented as the control section 20a and the communication section 20c. The game processing execution section 46 and the playing video generation section 50 are primarily implemented as the control section 20a. The session establishment section 48, the video transmission section 54, and the video-related information communication control section 58 are primarily implemented as the communication section 20c. The delivering user video generation section 52 is primarily implemented as the control section 20a and the camera 20f. The display control section 56 is primarily implemented as the control section 20a and the display section 20d.

The above functions are implemented as a result of execution of a program by the control section 20a. The program is installed in the gaming device 20, a computer, and includes instructions that correspond to the above functions. The program is supplied to the gaming device 20, for example, via a computer-readable information storage medium such as optical disc, magnetic disk, magnetic tape, magneto-optical disk, and flash memory. Alternatively, the program is supplied to the gaming device 20 via communication means such as the Internet.

On the other hand, as illustrated in FIG. 6, the information terminal 22 according to the present embodiment functionally includes, for example, a video transmission device association section 60, a video transmission device identification information storage section 62, a video-related information communication section 64, and a display control section 66. The video transmission device association section 60 is primarily implemented as the control section 22a and the communication section 22c. The video transmission device identification information storage section 62 is primarily implemented as the storage section 22b. The video-related information communication section 64 is primarily implemented as the communication section 22c. The display control section 66 is primarily implemented as the control section 22a and the touch panel 22d.

The above functions are implemented as a result of execution of a program by the control section 22a. The program is installed in the information terminal 22, a computer, and includes instructions that correspond to the above functions. The program is supplied to the information terminal 22, for example, via a computer-readable information storage medium such as optical disc, magnetic disk, magnetic tape, magneto-optical disk, and flash memory. Alternatively, the program is supplied to the information terminal 22 via communication means such as the Internet.

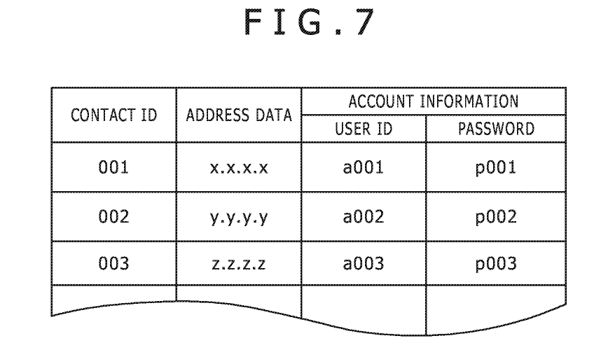

The contact management data storage section 40 stores contact management data illustrated in FIG. 7 that is used to manage the video delivery systems 12, contacts. As illustrated in FIG. 7, the contact management data includes contact IDs, address data, and account information for delivering users to log into the video delivery systems 12. The contact IDs are contact identifiers. The address data is the addresses of the video delivery systems 12, contacts. In the present embodiment, the account information includes user IDs and passwords. In the present embodiment, account information of a delivering user registered in each of the plurality of video delivery systems 12 may be different as described above. In the present embodiment, different account information can be stored in the contact management data storage section 40 for each of the plurality of video delivery systems 12, contacts, as illustrated in FIG. 7. This makes it possible for the gaming device 20 to log into each of the plurality of video delivery systems 12 using account information that corresponds to the video delivery system 12. It should be noted that the contact management data storage section 40 may store a token obtained as a result of login to the video delivery system 12 using a user ID and a password.

The terminal association section 42 and the video transmission device association section 60 associate the gaming device 20 and the information terminal 22 by performing a pairing process.

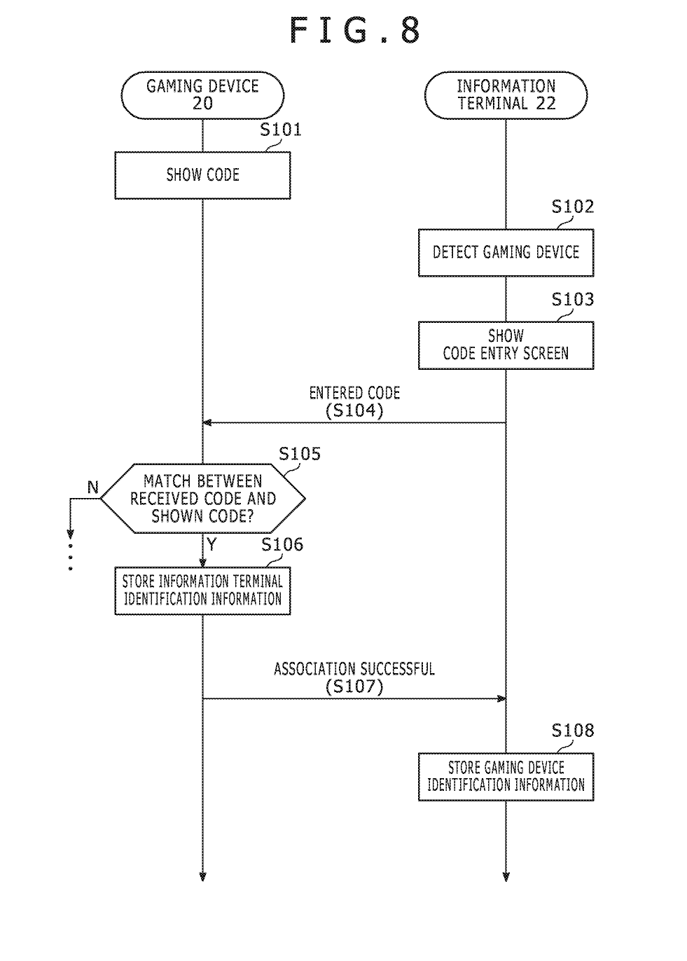

A description will be given here of an example of a pairing process with reference to the flowchart illustrated in FIG. 8.

First, when a delivering user performs a given operation to show a code on the gaming device 20, the terminal association section 42 shows, on the display section 20d, the code, a character string to be entered into the information terminal 22 (S101).

Then, when the delivering user performs a given operation to start association on the information terminal 22, the video transmission device association section 60 detects the gaming device 20 in the same segment that is connected via the router 24 (S102).

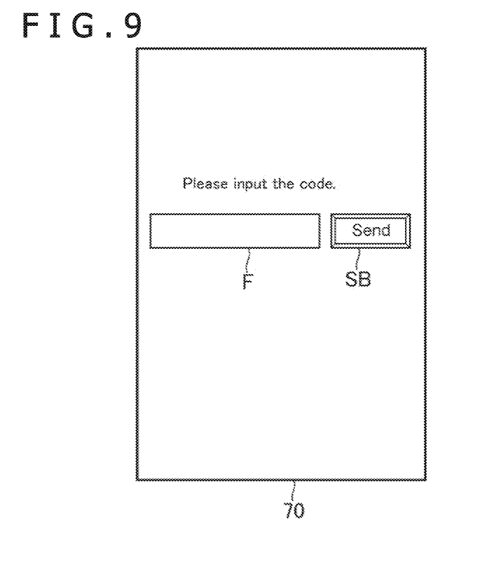

Then, the video transmission device association section 60 shows a code entry screen 70 illustrated in FIG. 9 on the touch panel 22d of the information terminal 22 (S103).

We assume here that the delivering user enters, into the form F of the code entry screen 70, the code appearing on the display section 20d of the gaming device 20 by performing the process in S101 and taps the send button SB. As a result, the video transmission device association section 60 sends the code entered into the form F to the gaming device 20 that has been detected by the process in 5102. Then, the terminal association section 42 of the gaming device 20 receives the code (S104).

Then, the terminal association section 42 determines whether or not the code received by the process in S104 matches that shown by the process in S101 (S105). If determining that the two codes do not match (N in S105), the terminal association section 42 sends, to the information terminal 22, information to the effect that the association failed, thus terminating the processes in the present processing example although such an entry is not shown in FIG. 8.

On the other hand, when determining that the two codes match (Y in S105), the terminal association section 42 stores identification information of the information terminal 22, address and other information of the information terminal 22 that sent the code, in the terminal identification information storage section 44 (S106).

Then, the terminal association section 42 sends, to the information terminal 22, information to the effect that the association succeeded. Then, the video transmission device association section 60 of the information terminal 22 receives the information to the effect that the association succeeded (S107).

As a result, the video transmission device association section 60 stores, in the video transmission device identification information storage section 62, identification information of the gaming device 20 such as address of the gaming device 20 detected by the process in S102 (S108), thus terminating the processes in the present processing example.

The association between the gaming device 20 and the information terminal 22 takes place as described above. The terminal association section 42 handles association with the information terminal 22 as described above. Then, the video transmission device association section 60 handles association with the gaming device 20.

The terminal identification information storage section 44 stores identification information of the information terminal 22 associated by the terminal association section 42 as described above.

The video transmission device identification information storage section 62 stores identification information of the video transmission device associated by the video transmission device association section 60 as described above. In the present embodiment, the video transmission device identification information storage section 62 stores identification information of the gaming device 20.

The game processing execution section 46 executes the game program installed in the gaming device 20. Further, the game processing execution section 46 changes a game status in response to an operation input accepted from the controller 20e.

The session establishment section 48 logs, in response to an operation for specifying the video delivery system 12 that performs live streaming delivery by the delivering user, into the specified video delivery system 12 as described above. Then, the session establishment section 48 establishes a communication session with the video delivery system 12. It should be noted that if the above token is stored in the contact management data storage section 40, the session establishment section 48 may establish a communication session with the video delivery system 12 using the token.

The playing video generation section 50 generates a playing video representing playing details of the game in accordance with the game execution status of the program by the game processing execution section 46.

The delivering user video generation section 52 generates a delivering user video, a video showing the delivering user playing the game.

The video transmission section 54 sends the video to the video delivery system 12, the destination of the video. In the present embodiment, the playing video transmission unit 54a sends the playing video generated by the playing video generation section 50 to the video delivery system 12, the destination. Further, the delivering user video transmission unit 54b sends the delivering user video generated by the delivering user video generation section 52 to the video delivery system 12, the destination of the video. The playing video and the arrangement user video sent are arranged in the viewing screen 30. It should be noted that there is no need to send playing and delivering user videos separately as described above. For example, the video transmission section 54 may generate a frame image of the viewing screen 30 illustrated in FIG. 3 based on frame images of playing and delivering user videos first, and then send a video made up of the frame image to the video delivery system 12.

The display control section 56 generates the playing screen 32 illustrated in FIG. 4 that contains the frame image of the playing video, showing the playing screen 32 on the display section 20d.

The video-related information communication control section 58 performs control such that the above video-related information can be communicated between the information terminal 22 associated by the terminal association section 42 and the video delivery system 12 delivering the playing video. Further, the video-related information communication control section 58 performs control such that video-related information on a playing video can be communicated with the video delivery system 12 delivering the playing video. It should be noted here that control may be performed such that video-related information on a playing video can be communicated with the video delivery system 12 delivering the playing video at least for part of a period of time in which the playing video is delivered by live streaming.

In the present embodiment, the video-related information communication control section 58, for example, receives video-related information such as the comments C from the video delivery systems 12 and sends them to the associated information terminal 22. The comments C are posted to the video delivery systems 12 from delivering and viewing users. The destination of the comments C and other information can be identified based on identification information of the information terminal 22 stored in the terminal identification information storage section 44.

It should be noted that among examples of video-related information sent to the information terminal 22 that is related to the comment C are posting date and time, elapsed time from the beginning of live, language, poster's name of the comment C (anonymity allowed). Further, among other examples thereof are poster's attribute (whether or not the poster is a deliverer, a premium member, an ordinary member, or an operator), display-related information such as character color and font, data for readout, filtering parameter, and various other types of metadata.

Further, among examples of video-related information sent to the information terminal 22 that is related to a channel delivering videos are language, channel name, explanatory note of the channel, community, and viewer count. Further, among other examples thereof are comment count, information representing restrictions such as age and area, channel thumbnail (or its URL (Uniform Resource Locator)), and various other types of metadata.

Among examples of video-related information sent to the information terminal 22 that is related to a deliverer are information such as language and deliverer's name and deliverer's or his or her avatar's image (or its URL). Further, among other examples thereof are information representing deliverer's attribute (whether the deliverer is a premium member or non-member, or an operator) and various other types of metadata.

Among examples of video-related information sent to the information terminal 22 that is related to a game are information representing game's name, genre, and so on and other information added by the game to the video as metadata such as stage count.

Further, among examples of video-related information sent to the information terminal 22 are URLs to websites for applying for a premium service and an extension procedure. These URLs may be those to websites on the video delivery system 12 or those to websites prepared by the gaming device 20.

Still further, among examples of video-related information sent to the information terminal 22 that is related to advertisement are advertisement insertion request, advertisement information shown and its URL, and various other types of metadata.

Still further, videos sent from the video transmission section 54 may be sent to the information terminal 22 as video-related information.

Still further, in the present embodiment, the video-related information communication control section 58 performs control such that the information terminal 22 can post comments via a communication session for sending playing videos established between the information terminal 22 and the video delivery system 12. More specifically, for example, the video-related information communication control section 58 sends the comment C, received from the information terminal 22, to the video delivery system 12, the destination of playing videos. Thus, in the present embodiment, the video-related information communication control section 58 relays communication of video-related information with the video delivery system 12, the destination of playing videos.

It should be noted that among examples of video-related information sent from the information terminal 22 that is related to the comments C is video-related information related to the comments C of the above video-related information that is sent to the information terminal 22.

Further, among examples of video-related information sent from the information terminal 22 that is related to a channel delivering videos is video-related information related to a deliverer of the above video-related information that is sent to the information terminal 22.

Still further, among examples of video-related information sent from the information terminal 22 that is related to advertisement is video-related information related to advertisement of the above video-related information that is sent to the information terminal 22.

Other than the above, if the information terminal 22 has a camera and a microphone, for example, among examples of video-related information sent from the information terminal 22 are images captured by the camera of the information terminal 22 and sounds entered into the information terminal 22 by a user, for example.

The video-related information communication section 64 communicates, with the video delivery system 12, video-related information on a video managed by the video delivery system 12, the destination of the video sent from the video transmission device that is associated by the video transmission device association section 60. In the present embodiment, the video-related information communication section 64 receives, from the gaming device, information on a playing video such as the comments C posted to the video delivery system 12 from delivering and viewing users. Playing video information is relayed by the video-related information communication control section 58 of the gaming device 20.

Further, the video-related information communication section 64 is controlled such that video-related information on a playing video can be communicated with the video delivery system 12 delivering the playing video. It should be noted here that the video-related information communication section 64 may be controlled such that video-related information on a playing video can be communicated with the video delivery system 12 delivering the playing video at least for part of a period of time in which the playing video is delivered by live streaming.

Still further, in the present embodiment, the video-related information communication section 64 sends the comment C, entered via the auxiliary screen 34, to the gaming device 20. The comment C is relayed by the video-related information communication control section 58 of the gaming device 20 and sent to the video delivery system 12, the destination of the playing video. The destination of the comment C can be identified based on identification information of the gaming device 20 stored in the video transmission device identification information storage section 62.

The display control section 66 generates the auxiliary screen 34 or various other screens, showing the generated screen on the touch panel 22d. The display control section 66 generates, for example, the auxiliary screen 34 based on information on the playing video such as the comment C received from the gaming device 20, showing the auxiliary screen 34 on the touch panel 22d.

It should be noted that each of the first, second and up to m-th video delivery systems 12-1, 12-2 and up to 12-m communicates with the gaming device 20 by a different communication scheme. Then, the video-related information communication control section 58 communicates, with the video delivery system 12, the destination of the playing video, information on the playing video by a communication scheme in keeping with the video delivery system 12. On the other hand, the video-related information communication control section 58 uses a common communication scheme independent of the video delivery system 12, the destination of the playing video, for communication between the gaming device 20 and the information terminal 22 associated with each other. In this case, even if the information terminal 22 cannot use the communication scheme used for communication between the gaming device 20 and the video delivery system 12, the information terminal 22 can communicate, with the video delivery system 12, information related to the playing video.

In the present embodiment, when a delivering user performs an operation to specify which video delivery system 12 to use for delivery of a playing video, the session establishment section 48 establishes a communication session with the video delivery system 12 as described above. Then, the delivery of the playing video to a viewing user begins using the specified video delivery system 12.

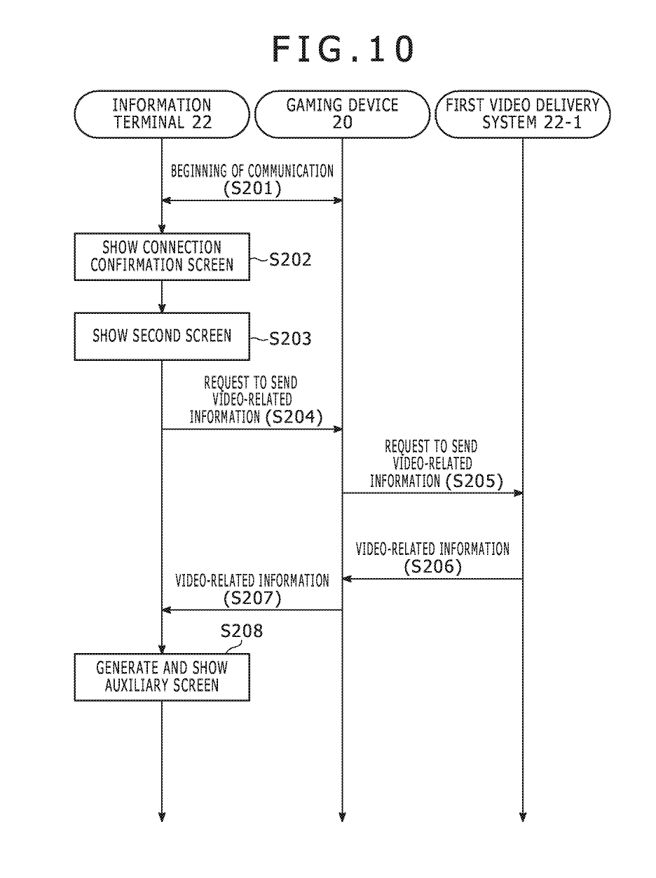

A description will be given here of an example of a processing flow for showing the auxiliary screen 34, illustrated in FIG. 5, on the touch panel 22d of the information terminal 22 when the delivery of a playing video is in progress, with reference to the flowchart illustrated in FIG. 10. In the present processing example, we assume that a communication session is established between the gaming device 20 and the first video delivery system 12-1.

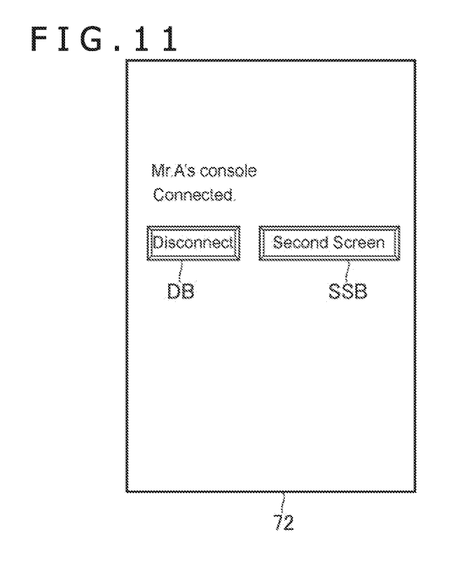

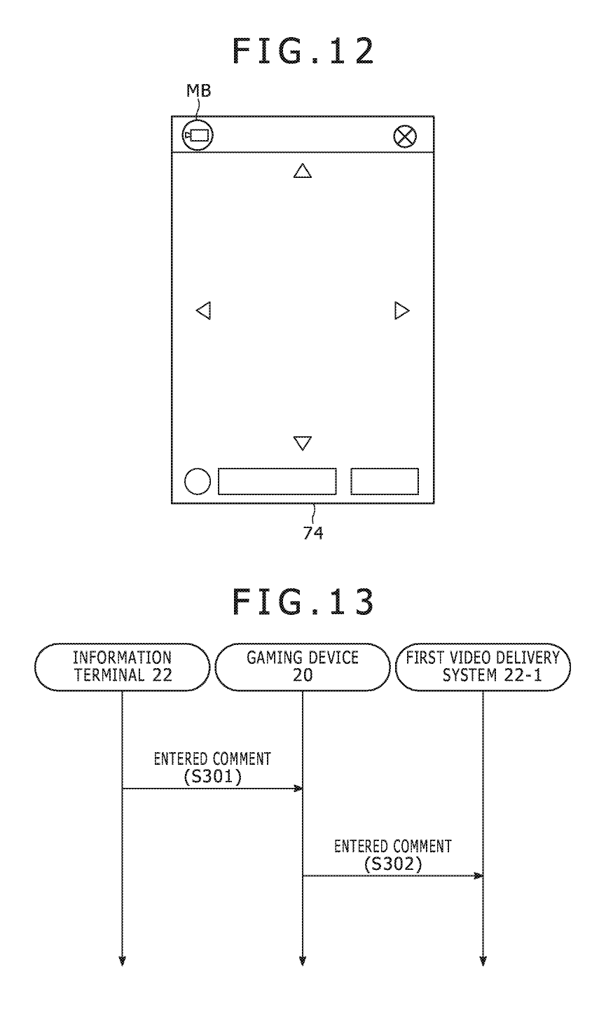

When the delivering user performs a given operation to confirm a connection on the information terminal 22, the video-related information communication section 64 begins communication with the gaming device 20 whose identification information is stored in the video transmission device identification information storage section 62 of the information terminal 22 (S201). Then, the display control section 66 shows a connection confirmation screen 72 illustrated in FIG. 11 on the touch panel 22d (S202). The connection confirmation screen 72 contains a disconnect button DB and a second screen display button SSB. When the delivering user taps the disconnect button DB here, the communication between the information terminal 22 and the gaming device 20 is disconnected. In the present processing example, we assume that the delivering user taps the second screen display button SSB. In this case, the display control section 66 shows a second screen 74 illustrated in FIG. 12 on the touch panel 22d (S203). The delivering user can make, to the gaming device 20, operation inputs similar to those that can be made to the gaming device 20 by the controller 20e, by tapping the second screen 74.

Further, the second screen 74 contains a video-related information display button MB. When the delivering user taps the video-related information display button MB, the video-related information communication section 64 sends, to the gaming device 20, a request to send video-related information managed by the first video delivery system 12-1. As a result, the video-related information communication control section 58 of the gaming device 20 receives the sending request (S204). Then, the video-related information communication control section 58 sends a request to send video-related information to the first video delivery system 12-1 (S205). As a result, the first video delivery system 12-1 sends the video-related information to the gaming device 20 in response to the sending request received. As a result, the video-related information communication control section 58 of the gaming device 20 receives the video-related information (S206). Then, the video-related information communication control section 58 sends the received video-related information to the information terminal 22. As a result, the video-related information communication section 64 of the information terminal 22 receives the video-related information (S207). Then, the display control section 66 of the information terminal 22 generates the auxiliary screen 34 illustrated in FIG. 5 based on the received video-related information, showing the auxiliary screen 34 on the touch panel 22d (S208).

From here onward, when a delivering or viewing user posts the comment C to the first video delivery system 12-1, video-related information updated in response to the post is sent to the gaming device 20. Then, the video-related information communication control section 58 of the gaming device 20 sends the video-related information to the information terminal 22. The video-related information communication section 64 of the information terminal 22 receives the video-related information. Then, the display control section 66 of the information terminal 22 updates the auxiliary screen 34 illustrated in FIG. 5 based on the received video-related information. Thus, the auxiliary screen 34 is updated in response to the updating of video-related information managed by the first video delivery system 12-1.

Although, in the above processing example, the auxiliary screen 34 is generated by the information terminal 22 based on video-related information, the video delivery system 12 may generate data representing a webpage equivalent to the auxiliary screen 34 and send the data to the gaming device 20. Then, the video-related information communication section 64 may relay the data to send it to the information terminal 22. Then, the display control section 66 may show the webpage represented by the data as the auxiliary screen 34. In this case, the design of the auxiliary screen 34 is controlled by the video delivery system 12. Further, the auxiliary screen 34 appears on the touch panel 22d, the auxiliary screen 34 having a design in keeping with the video delivery system 12, the destination of videos.

Further, the video-related information communication control section 58 may generate data representing a webpage equivalent to the auxiliary screen 34 based on video-related information received from the video delivery system 12, sending the data to the information terminal 22. Then, the video-related information communication section 64 may receive the data. In this case, the video-related information communication control section 58 may generate data representing a webpage with a design in keeping with the video delivery system 12, the destination of videos, transmitting the data to the information terminal 22. Then, the display control section 66 may show the webpage represented by the data as the auxiliary screen 34. In this case, the design of the auxiliary screen 34 is controlled by the gaming device 20.

A description will be given next of an example of a processing flow when a delivering user enters the comment C into the auxiliary screen 34 and taps the send button SB with reference to the flowchart illustrated in FIG. 13.

When the delivering user taps the send button SB in the auxiliary screen 34, the video-related information communication section 64 of the information terminal 22 sends the comment C entered into the form F to the gaming device 20. Then, the video-related information communication control section 58 of the gaming device 20 receives the comment C (S301). Then, the video-related information communication control section 58 associates the comment C, received in the process illustrated in S301, with the poster's name information PU, sending the comment C to the first video delivery system 12-1 via a communication session established with the first video delivery system 12-1. Then, the first video delivery system 12-1 receives the comment C (S302). The poster's name information PU shows the delivering user's name as the poster's name. Thus, the comment C sent is associated with the posting date and time thereof by the first video delivery system 12-1 first, and then managed as the comment C associated with a playing video delivered by live streaming. Thus, in the present embodiment, when a communication session is established between the gaming device 20 and the video delivery system 12, the information terminal 22 and the video delivery system 12 can communicate video-related information such as the comment C with each other via the communication session.

It should be noted that the present invention is not limited to the above embodiment.

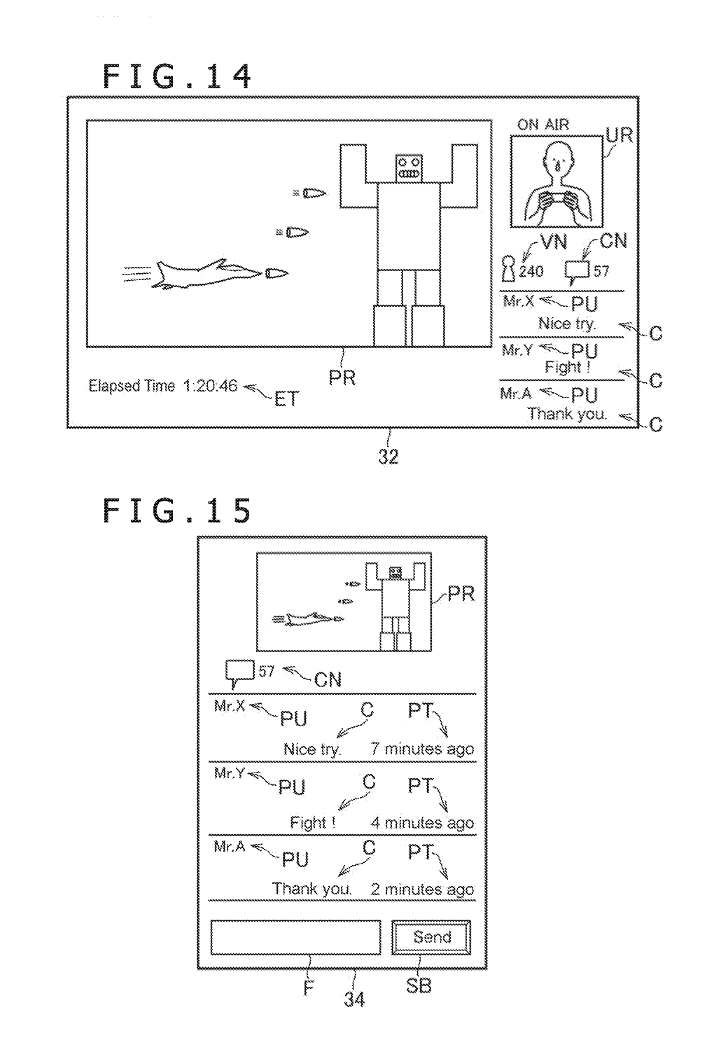

FIG. 14 is a diagram illustrating another example of the playing screen 32. For example, as illustrated in FIG. 14, the playing screen 32 may contain video-related information such as the comment C, the poster's name information PU, the viewing user count information VN, the comment count information CN, and the elapsed time information ET. Further, the playing screen 32 may also contain the delivering user video display area UR such that frame images making up the delivering user video are shown one after another in the delivering user video display area UR. Still further, the gaming device 20 may post the comment C to the video delivery system 12.

FIG. 15 is a diagram illustrating another example of the auxiliary screen 34. For example, as illustrated in FIG. 15, the auxiliary screen 34 may contain the playing video display area PR such that frame images making up the playing video are shown one after another in the playing video display area PR. In this case, a playing video delivered from the video delivery system 12 may be relayed by the gaming device 20, followed by reception thereof by the information terminal 22 such that the information terminal 22 shows the playing video on the touch panel 22d. Further, for example, the gaming device 20 may send a playing video to both the video delivery system 12 and the information terminal 22. Then, the information terminal 22 may show the playing video on the touch panel 22d.

Still further, the elapsed time information ET may be not managed by the video delivery system 12, and may be done so, for example, by the gaming device 20. Still further, the elapsed time information ET may represent the time elapsed from the beginning of the delivery of the playing video by live streaming rather than that from the beginning of the game play.

Still further, each of the gaming device 20 and the information terminal 22 may include a plurality of housings.

Yet further, the above specific character strings and those in the drawings are illustrative, and the present invention is not limited thereto.

1. A video transmission device comprising:
a video transmission section adapted to send, to a video delivery system operable to deliver videos by live streaming, a video to be delivered by the video delivery system; and
a communication control section adapted to control a terminal associated with the video transmission device such that information on the video managed by the video delivery system can be communicated with the video delivery system.

2. The video transmission device of claim 1, wherein
information on the video is comments posted from users viewing the video that is delivered by the video delivery system by live streaming.

3. The video transmission device of claim 2, wherein
the communication control section performs control such that the terminal can post comments via a communication session established between the terminal and the video delivery system and used by the video transmission section to send the video.

4. The video transmission device of claim 1, wherein
the communication control section relays communication of information on the video managed by the video delivery system between the video delivery system, the destination of the video sent from the video transmission section, and the terminal,
the video transmission section sends the video by a communication scheme that is in keeping with the video delivery system, the destination of the video, and
the video transmission section communicates, with the terminal, the information on the video managed by the video delivery system, the destination of the video, by a common communication scheme that is independent of the video delivery system, the destination of the video sent from the video transmission section.

5. The video transmission device of claim 1, wherein
the terminal is a terminal that can be used by the video delivery system independently of the video transmission device.

6. A terminal comprising:
a communication section adapted to communicate, with a video delivery system that delivers videos by live streaming and is the destination of the video sent from a video transmission device, information on the video managed by the video delivery system, the video transmission device sending the video to be delivered by the video delivery system and being associated with the terminal, wherein
the communication section is controlled such that information on the video managed by the video delivery system, the destination of the video sent from the video transmission device, can be communicated with the video delivery system.

7. A video transmission system comprising:
a video transmission device; and
a terminal, wherein
the video transmission device includes
a video transmission section adapted to send, to a video delivery system that delivers videos by live streaming, a video to be delivered by the video delivery system, and
a communication control section adapted to control the terminal associated with the video transmission device such that information on the video managed by the video delivery system can be communicated with the video delivery system,
the terminal includes
a communication section adapted to communicate, with the video delivery system that is the destination of the video sent from the video transmission device, information on the video managed by the video delivery system, and
the communication section is controlled such that the information on the video managed by the video delivery system, the destination of the video sent from the video transmission device, can be communicated with the video delivery system.

8. A control method comprising:
sending, by a video transmission device, a video to be delivered by a video delivery system that delivers videos by live streaming to the video delivery system; and
controlling a terminal associated with the video transmission device such that information on the video managed by the video delivery system can be communicated with the video delivery system.

9. A control method comprising:
communicating, by a terminal associated with a video transmission device sending a video to be delivered by a video delivery system, the destination of the video sent from the video transmission device by live streaming to the video delivery system, information on the video managed by the video delivery system with the video delivery system; and
performing control such that information on the video managed by the video delivery system, the destination of the video sent from the video transmission device, can be communicated between the video delivery system and the terminal.

10. A non-transitory, computer readable storage medium containing a computer program, which when executed by a computer, causes the computer to perform actions, comprising:
sending, by a video transmission section, to a video delivery system that delivers videos by live streaming, a video to be delivered by the video delivery system; and
controlling, by a communication control section, a terminal associated with the computer such that information on the video managed by the video delivery system can be communicated with the video delivery system.

11. (canceled)

12. A non-transitory, computer readable storage medium containing a computer program, which when executed by a computer, causes the computer to perform actions, comprising:
communicating, by a communication section, with a video delivery system that delivers videos by live streaming and is the destination of a video sent from a video transmission device, information on the video managed by the video delivery system, the video transmission device sending the video to be delivered by the video delivery system and being associated with the computer, wherein
the computer is controlled such that information on the video managed by the video delivery system, the destination of the video sent from the video transmission device, can be communicated with the video delivery system.

13. (canceled)
